(19) United States
(12) Patent Application Publication
(10) Pub. No.: US 2014/0119715 A1
(43) Pub. Date: May 1, 2014

(54) HEATER POWER CONTROL SYSTEM

(71) Applicant: GRACO MINNESOTA INC., Minneapollis, MN (US)

(72) Inventors: Joseph E. Tix, Hastings, MN (US); Daniel P. Ross, Maplewood, MN (US); Benjamin R. Godding, St. Cloud, MN (US); Mark J. Brudevold, Fridley, MN (US)

(73) Assignee: GRACO MINNESOTA INC., Minneapolis, MN (US)

(21) Appl. No.: 13/705,396

(22) Filed: Dec. 5, 2012

Related U.S. Application Data
(60) Provisional application No. 61/718,261, filed on Oct. 25, 2012.

(51) Int. Cl. B05C 5/00; H05B 1/02

(52) U.S. Cl. CPC B05C 5/001; H05B 1/0202
USPC 392/466; 219/507; 392/471

(57) ABSTRACT

A method includes delivering current in parallel to a first resistive heating element, a second resistive heating element and a third resistive heating element during a first operating mode of a hot melt dispensing system, and delivering current in parallel to the first resistive heating element, the second resistive heating element and third and fourth resistive heating elements during a second operating mode of a hot melt dispensing system where the third and fourth resistive heating elements are arranged in series.

### RELATED APPLICATION

This application is a non-provisional of U.S. Provisional Patent Application Ser. No. 61/718,261 filed Oct. 25, 2012, entitled “Heater Power Control System”.

### BACKGROUND

The present disclosure relates generally to systems for dispensing hot melt adhesive. More particularly, the present disclosure relates to controlling the power used for heating parts of the dispensing systems.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

A method includes delivering current in parallel to a first resistive heating element, a second resistive heating element and a third resistive heating element during a first operating mode of a hot melt dispensing system, and delivering current in parallel to the first resistive heating element, the second resistive heating element and third and fourth resistive heating elements during a second operating mode of a hot melt dispensing system where the third and fourth resistive heating elements are arranged in series.

A hot melt adhesive system includes a melter, a band heater, a pump, a melter base and a controller. The melter includes a first heater cartridge. The band heater surrounds at least a portion of the melter and includes a resistive heating element. The pump includes a second heater cartridge. The melter base is located between the melter and the pump, allows molten adhesive to flow from the melter to the pump, and includes a third heater cartridge. The controller causes current to be delivered to the resistive heating element, the second heater cartridge and the third heater cartridge in a first operating mode and causes current to be delivered to the resistive heating element, the third heater cartridge and a series combination of the first heater cartridge and the second heater cartridge in a second operating mode.

A method for heating a hot melt dispensing system includes delivering current to a pump heater and a first melter heater in parallel with the pump heater during a warmup mode and delivering current to the first melter heater in parallel with a series combination of the pump heater and a second melter heater during a running mode.

### BRIEF DESCRIPTION OF THE DRAWINGS

FIG. 1 is a schematic view of a system for dispensing hot melt adhesive.

FIG. 2 is a perspective view of the melt system of the system shown in FIG. 1.

FIG. 3 is a circuit diagram illustrating the configuration of the heating elements in the melt system shown in FIG. 2.

### DETAILED DESCRIPTION

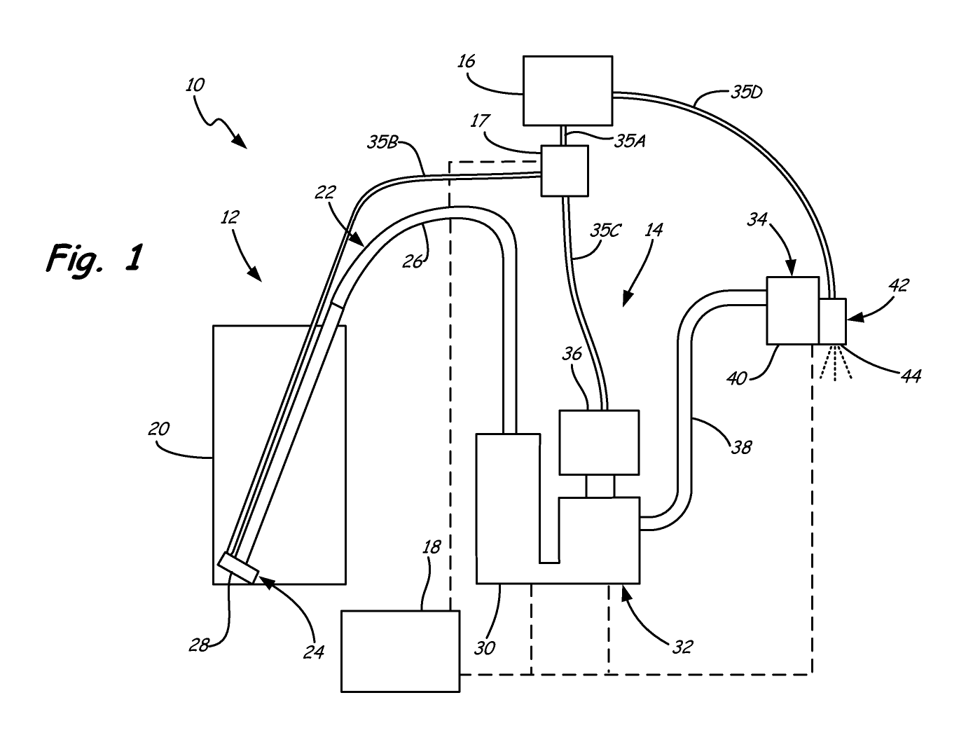

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene-based hot melt adhesives. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

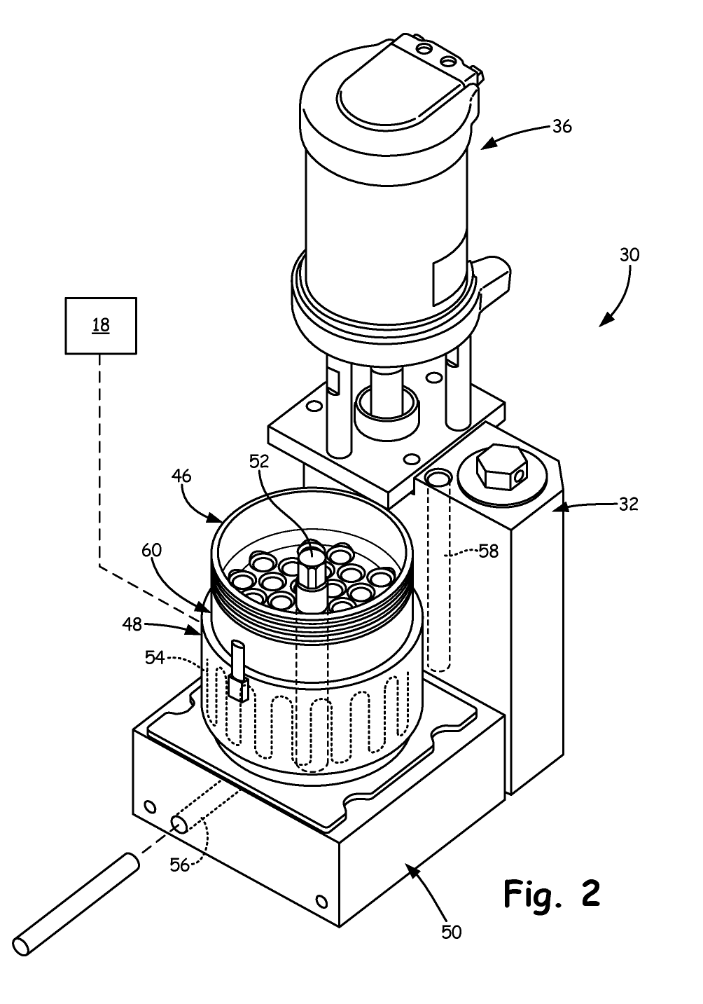

Solid adhesive pellets are delivered from feed hose 26 to melt system 30. Melt system 30 can include a container (shown in FIG. 2) and resistive heating elements (shown in FIG. 2) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30 to dispenser 34 through supply hose 38. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

FIG. 2 is a perspective view of melt system 30. As shown in FIG. 2, melt system 30 includes pump 32, motor 36, melter 46, band heater 48 and melter base 50. In FIG. 2, a cap that normally is located on top of melter 46 has been removed so that internal features of melter 46 can be seen. Melter 46 is a melting vessel in which solid adhesive pellets are heated to form a hot melt adhesive in liquid form. Solid adhesive pellets enter melter 46 from a hopper (not shown) or feed hose 26. Melter 46 sits atop melter base 50 and can include features to increase the contact surface area within melter 46 such as channels, ribs and fins. Heat is supplied to melter 46 by an internal heating element and/or band heater 48. In the embodiment shown in FIG. 2, heater cartridge 52 is located within melter 46 near the center of the melting vessel. Heater cartridge 52 can be a tube-shaped joule heating element. As current passes through heater cartridge 52, heat is transferred into melter 46. Alternatively, other types of heating elements can be located within melter 46.

Band heater 48 surrounds at least a portion of melter 46. As shown in FIG. 2, melter 46 is generally cylindrical and band heater 48 is a cylindrical tube-like structure that surrounds melter 46. Band heater 48 includes a heating element. In the embodiment shown in FIG. 2, resistive heating element 54 is embedded within band heater 48 (shown as dashed line 54). As current passes through resistive heating element 54, heat is transferred through band heater 48 and melter 46. Band heater 48 can extend upwards the from the bottom of melter 46 where melter 46 meets melter base 50 to cover all or a substantial portion of melter 46. Alternatively, band heater 48 can surround melter 46 generally only where solid adhesive pellets enter melter 46.

Melter base 50 is located below melter 46 and band heater 48. Melter base 50 contains a passageway that allows melted liquid hot melt adhesive to travel from melter 46 to pump 32. Thus, once the hot melt adhesive has been melted in melter 46, it is delivered to pump 32 via melter base 50. Pump 32 then delivers the liquid hot melt adhesive to dispenser 34 as shown in FIG. 1. Melter base 50 is heated so that the liquid hot melt adhesive present in melter base 50 remains in liquid form and can flow to pump 32. In the embodiment shown in FIG. 2, melter base 50 is heated by heater cartridge 56 that is inserted into melter base 50. FIG. 2 illustrates heater cartridge 56 within melter base 50. Heater cartridge 56 can be a tube-shaped joule heating element similar to heater cartridge 52.

As noted above, pump 32 pumps liquid hot melt adhesive from melt system 30 to dispenser 34. Pump 32 can include a heating element to supply heat to pump 32 to ensure that any liquid hot melt adhesive present in pump 32 remains in liquid form. In the embodiment shown in FIG. 2, pump 32 is heated by heater cartridge 58 that is inserted into pump 32. FIG. 2 illustrates heater cartridge 58 within pump 32. Heater cartridge 58 can be a tube-shaped joule heating element similar to heater cartridges 52 and 56.

Melt system 30 can also include temperature sensor 60 to determine the temperature of one or more components of melt system 30. As shown in FIG. 2, temperature sensor 60 is located between band heater 48 and melter 46. Temperature sensor 60 can also be located in other parts of melt system 30. Temperature sensor 60 communicates the temperature of melt system 30 to controller 18.

Melt system 30 can be heated differently in differing operating modes. For example, melt system 30 is cold (ambient temperature) at the start of a shift, before operation of system 10 has been initiated. In this scenario, melt system 30 must typically be “warmed up” before solid adhesive pellets are added to melter 46 to facilitate proper flow of the adhesive through system 10. In a first operating mode (warmup mode), melt system 30 is heated so that several components are “hot” before running pump 32 in order to dispense liquid hot melt adhesive. Band heater 48, melter base 50 and pump 32 are heated during the first operating mode. Electric current is delivered to resistive heating element 54 to heat band heater 48, to heater cartridge 56 to heat melter base 50 and to heater cartridge 58 to heat pump 32. In one embodiment, electric current is delivered to resistive heating element 54, heater cartridge 56 and heater cartridge 58 in parallel in a first operating mode to warm up melt system 30. Delivering electric current in this manner allows components of melt system 30 to reach an elevated temperature that will enable liquid hot melt adhesive to flow through melt system 30 from melter 46 to dispenser 34.

Once melt system 30 has warmed up to a particular temperature, melt system 30 is heated differently so that the heat delivered to the system is generally focused on melting the solid adhesive pellets that are or will be introduced into melter 46. In this second operating mode (“running mode”), electric current is delivered to heating elements in melt system 30 differently than in the first operating mode. Band heater 48, melter base 50, melter 46 and pump 32 are heated during the second operating mode. Electric current is delivered to resistive heating element 54 to heat band heater 48, to heater cartridge 56 to heat melter base 50, to heater cartridge 52 to heat melter 46 and to heater cartridge 58 to heat pump 32. In one embodiment, electric current is delivered to resistive heating element 54, heater cartridge 56 and a series combination of heater cartridge 52 and heater cartridge 58 in the second operating mode. According to this embodiment, melt system 30 is heated so that energy is focused to melt solid adhesive pellets entering melter 46 during the second operating mode.

While pump 32 can remain heated in the second operating mode, it requires less heat while melt system 30 is running. The heat added to band heater 48 and melter 46 causes the solid adhesive pellets to melt into liquid hot melt adhesive in melter 46. From there the liquid adhesive travels through melter base 50 to pump 32. The heat added to the adhesive by melter 46, band heater 48 and melter base 50 is generally sufficient to ensure that the adhesive will stay in liquid form until it reaches dispenser 34. Pump 32 does not need to add additional heat to the adhesive. Heating pump 32 too much while system 10 is actively dispensing adhesive can create disadvantages. For example, heating the adhesive too much within pump 32 has the potential to cause the adhesive to discolor. By arranging the heating elements of pump 32 and melter 46 in series during the second operating mode, the resistances of heater cartridges 52 and 58 reduce the amount of power drawn by heater cartridge 52 and the amount of heat generated by heater cartridge 52. This allows pump 32 to remain heated at an appropriate level while also reducing the power used to heat melt system 30 while system 10 is running.

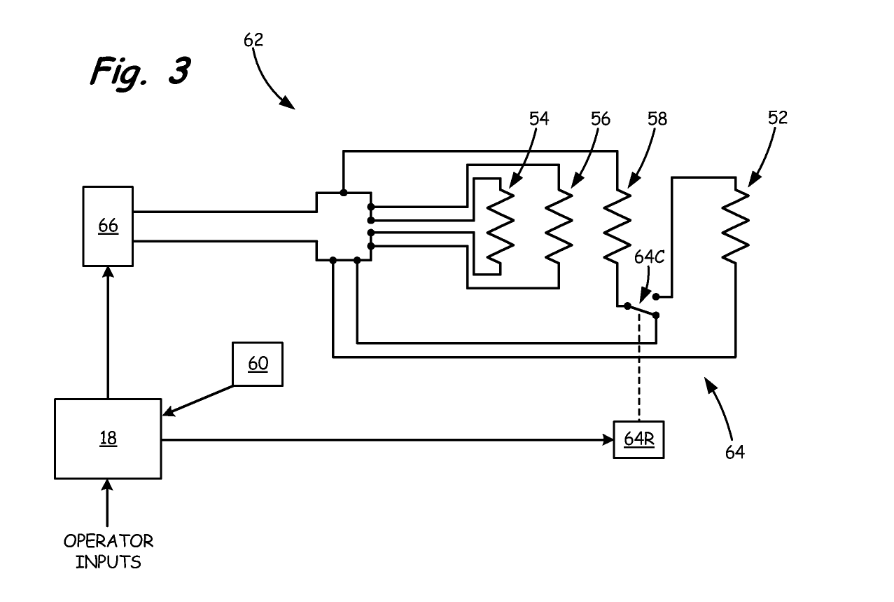

FIG. 3 is a circuit diagram illustrating the configuration of the heating elements in one embodiment of melt system 30. FIG. 3 illustrates circuit 62, which includes control relay 64 (with relay coil 64R and switch contacts 64C), current source 66, heater cartridge 52, resistive heating element 54, heater cartridge 56 and heater cartridge 58 and temperature sensor 60. Control relay 64 and current source 66 are controlled by controller 18 based on operator inputs and sensed temperature feedback from temperature sensor 60. Circuit 62 operates in a first operating mode (“warmup mode W”) and a second operating mode (“running mode R”).

Switch contacts 64C are shown in FIG. 3 in a first position for warmup mode W, in which resistive heating element 54, heater cartridge 56 and heater cartridge 58 are connected in parallel. As a result, the current from current supply 66 is divided based upon the relative resistances of element 54, cartridge 56 and cartridge 58. The fraction of the total current flowing through one parallel leg of the current divider is equal to the total resistance of the other legs (R_{T}) divided by the sum of the resistance of the leg (R_{X}) plus the total resistance R_{T} of the other legs. Thus, the larger the resistance R_{X}, the smaller the fraction of the total current that flows through that leg. No electric current is sent to heater cartridge 52 in warmup mode W.

In running mode R, switch contacts 64C connect heater cartridge 58 and heater cartridge 52 in series. As a result, the fraction of current flowing through that leg is decreased in running mode R.

The position of switch contacts 64C is determined by controller 18. In one embodiment, controller 18 receives information from temperature sensor 60 and determines whether melt system 30 has warmed up enough and is at a high enough temperature to transition from the first operating mode to the second operating mode. The temperature at which circuit 62 transitions from the first operating (warmup) mode to the second operating (running) mode can depend on the solid adhesive chosen. In some embodiments, circuit 62 transitions from the first operating mode to the second operating mode once temperature sensor 60 registers a temperature between 100° F. (38° C.) and 500° F. (260° C.), and more preferably, between 200° F. (93° C.) and 450° F. (232° C.).

Due to the series configuration of pump and melter heating elements 58 and 52, the power drawn during running mode R is lower than the power drawn during warmup mode W. In some embodiments, the power drawn during running mode R is less than or equal to 70% of the power drawn during warmup mode W. The current delivered to the heating elements is also lower during running mode R compared to the warmup mode W. In some embodiments, the current delivered during running mode R is less than or equal to 70% of the current delivered during warmup mode W. Due to the series configuration of the pump and melter heating elements and the resistances of these heating elements, the power drawn by the combination of the pump and melter heating elements during running mode R is lower than that drawn by the pump heating element during warmup mode W. In some embodiments, the power drawn by pump and melter heating elements 58 and 52 during the second operating mode is less than or equal to 25% of the power drawn by the pump heating element during warmup mode W. Additionally, the power drawn by the pump heating element (heater cartridge 58) is significantly lower in running mode R than that of warmup mode W. In some embodiments, the power drawn by heater cartridge 58 during running mode R is less than or equal to 10% of the power drawn by heater cartridge 58 during warmup mode W.

### EXAMPLE

The following Table 1 and description illustrate one potential embodiment of the heating arrangement of melt system 30.

TABLE 1

| | | Warmup mode (W) | Running mode (R) |
|---|---|---|---|
| | Base wattage | Wattage | Wattage |
| Band heater | 1250 | 1250 | 1250 |
| Melter base | 1000 | 1000 | 1000 |
| Pump | 1500 | 1500 | 94 |
| Melter | 500 | 0 | 281 |

| | | |
|---|---|---|
| Total | 3750 | 2625 |
| Amperes at 240 V | 16 | 11 |

In this Example, the base wattage of resistive heating element 54 of band heater 54 is 1250 watts (W), the base wattage of heater cartridge 56 of melter base 50 is 1000 W, the base wattage of heater cartridge 58 of pump 32 is 1500 W and the base wattage of heater cartridge 52 of melter 46 is 500 W. In the first operating (warmup) mode, resistive heating element 54, heater cartridge 56 and heater cartridge 58 are arranged in parallel. This arrangement in the first operating mode draws 3750 W of total power with an electric current of 16 amperes (amps) at 240 volts (V). As each heating element is powered in parallel, the power drawn by each heating element is equal to its base wattage (1250 W for resistive heating element 54, 1000 W for heater cartridge 56 and 1500 W for heater cartridge 58).

In the second operating (running) mode, resistive heating element 54, heater cartridge 56 and the series combination of heater cartridge 58 and heater cartridge 52 are arranged in parallel. Heater cartridge 58 has a resistance of 38.4 ohms and heater cartridge 52 has a resistance of 115.2 ohms. The power drawn by each heating element differs from that of the first operating mode due to the series combination of heater cartridge 58 and heater cartridge 52. While resistive heating element 54 still draws 1250 W and heater cartridge 56 still draws 1000 W, heater cartridge 58 now draws 94 W instead of 1500 W. Additionally, heater cartridge 52 draws 281 W of power. This arrangement in the second operating mode draws 2625 W of total power with an electric current of 11 amps at 240 V.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method comprising:
delivering current in parallel to a first resistive heating element, a second resistive heating element and a third resistive heating element during a first operating mode of a hot melt dispensing system; and
delivering current in parallel to the first resistive heating element, the second resistive heating element and third and fourth resistive heating elements during a second operating mode of a hot melt dispensing system, wherein the third and fourth resistive heating elements are arranged in series.

2. The method of claim 1, further comprising:
sensing a temperature of the hot melt dispensing system, wherein current is delivered according to the second operating mode once the hot melt dispensing system is at a temperature between 100° F. (38° C.) and 500° F. (260° C.).

3. The method of claim 1, wherein power drawn during the second operating mode is less than or equal to about 70% of power drawn during the first operating mode.

4. The method of claim 1, wherein the current delivered during the second operating mode is less than or equal to about 70% of the current delivered during the first operating mode.

5. The method of claim 1, wherein the hot melt dispensing system comprises:
a melter heated by the fourth resistive heating element;
a band heater surrounding at least a portion of the melter, wherein the band heater is heated by the first resistive heating element;
a pump heated by the third resistive heating element; and
a melter base located between the melter and the pump that allows molten adhesive to flow from the melter to the pump, wherein the melter base is heated by the second resistive heating element.

6. The method of claim 5, wherein during the second operating mode, the third resistive heating element draws less than or equal to about 10% of the power drawn by the third resistive heating element during the first operating mode.

7. The method of claim 5, wherein the power drawn by the third resistive heating element in the first operating mode is greater than the power drawn by both the third and fourth resistive heating elements in the second operating mode.

8. The method of claim 5, wherein the power drawn by the third and fourth resistive heating elements in the second operating mode is less than or equal to about 25% of the power drawn by the third resistive heating element during the first operating mode.

9. A hot melt adhesive system comprising:
a melter comprising a first heater cartridge;
a band heater surrounding at least a portion of the melter comprising a resistive heating element;
a pump comprising a second heater cartridge;
a melter base located between the melter and the pump that allows molten adhesive to flow from the melter to the pump, the melter base comprising a third heater cartridge; and
a controller that causes current to be delivered to the resistive heating element, the second heater cartridge and the third heater cartridge in a first operating mode and causes current to be delivered to the resistive heating element, the third heater cartridge and a series combination of the first heater cartridge and the second heater cartridge in a second operating mode.

10. The system of claim 9, further comprising:
a control switch that electrically connects the first heater cartridge and the second heater cartridge in series in the second operating mode.

11. The system of claim 9, further comprising:
a temperature sensor for sensing the temperature of the melter to determine whether current can be delivered according to the second operating mode.

12. A method for heating a hot melt dispensing system, the method comprising:
delivering current to a pump heater and a first melter heater in parallel with the pump heater during a warmup mode; and
delivering current to the first melter heater in parallel with a series combination of the pump heater and a second melter heater during a running mode.

13. The method of claim 12, wherein the first melter heater is located generally circumferentially around the melter, and wherein the second melter heater is generally centrally located within the melter.

14. The method of claim 12, further comprising:
sensing a temperature of the hot melt dispensing system, wherein current is delivered according to the running mode once the hot melt dispensing system is at a temperature between 100° F. (38° C.) and 500° F. (260° C.).

15. The method of claim 12, wherein power drawn during running mode is less than or equal to about 70% of power drawn during the warmup mode.

16. The method of claim 12, wherein the current delivered during the running mode is less than or equal to about 70% of the current delivered during the warmup mode.

17. The method of claim 12, wherein during the running mode, the pump heater draws less than or equal to about 10% of the power drawn by the pump heater during the warmup mode.

18. The method of claim 12, wherein the power drawn by the pump heater in the warmup mode is greater than the power drawn by both the pump heater and the second melter heater in the running mode.

19. The method of claim 12, wherein the power drawn by the pump heater and the second melter heater in the running mode is less than or equal to about 25% of the power drawn by the pump heater during the warmup mode.
